(19) United States
(12) Patent Application Publication
(10) Pub. No.: US 2025/0166933 A1
(43) Pub. Date: May 22, 2025

(54) ELECTROCHEMICAL DEVICE

(71) Applicant: Panasonic Intellectual Property Management Co., Ltd., Osaka (JP)

(72) Inventors: Nao MATSUMURA, Osaka Fu (JP); Hideki SHIMAMOTO, Kyoto Fu (JP); Hiroki HAYASHI, Kyoto Fu (JP); Hideo SAKATA, Osaka Fu (JP)

(73) Assignee: Panasonic Intellectual Property Management Co., Ltd., Osaka (JP)

(21) Appl. No.: 18/841,607

(22) PCT Filed: Feb. 15, 2023
(86) PCT No.: PCT/JP2023/005199

§ 371 Date: Aug. 26, 2024

(30) Foreign Application Priority Data
Feb. 28, 2022 (JP) 2022-029103

(51) Int. Cl. H01G 11/28; H01G 11/06; H01G 11/48; H01M 4/02; H01M 4/1399; H01M 4/60; H01M 4/62; H01M 10/0525

(52) U.S. Cl. CPC H01G 11/28; H01G 11/06; H01G 11/48; H01M 4/1399; H01M 4/606; H01M 4/625; H01M 10/0525; H01M 2004/021; H01M 2004/028

(57) ABSTRACT

An electrochemical device disclosed includes a positive electrode, a negative electrode, and a lithium ion conductive electrolyte. The positive electrode includes a positive electrode mixture layer containing a positive electrode active material. The positive electrode active material contains particles of a conductive polymer to and from which anions are reversibly dopable and de-dopable. A ratio V1/V0 of a volume V1 of pores with a pore size of 0.2 μm or less to a volume V0 of all pores is 0.40 or more when a pore distribution of the positive electrode is measured using a mercury porosimeter.

### TECHNICAL FIELD

The present invention relates to an electrochemical device.

### BACKGROUND ART

In recent years, electrochemical devices having a configuration between that of lithium ion secondary batteries and that of electric double layer capacitors have been gaining attention.

PTL 1 (WO 2020/067169) discloses “an electrochemical device comprising a pair of electrodes and an electrolyte solution, wherein at least one of the pair of electrodes includes an electrode current collector and an electrode material layer supported by the electrode current collector, the electrode material layer includes at least a conductive polymer, a log differential pore volume distribution of the electrode material layer has at least one peak in a range of a pore diameter of more than or equal to 50 nm”.

### CITATION LIST

### Patent Literature

PTL 1: WO 2020/067169

### SUMMARY OF INVENTION

### Technical Problem

In recent years, there has been demand for improvement in a low-temperature property of electrochemical devices having a configuration between that of lithium ion secondary batteries and that of electric double layer capacitors. One object of the present disclosure is to provide an electrochemical device having an improved low-temperature property.

### Solution to Problem

One aspect of the present disclosure relates to an electrochemical device. The electrochemical device is an electrochemical device including a positive electrode; a negative electrode, and a lithium ion conductive electrolyte, in which the positive electrode includes a positive electrode mixture layer containing a positive electrode active material, the positive electrode active material contains particles of a conductive polymer to and from which anions are reversibly dopable and de-dopable, and a ratio V1/V0 of a volume V1 of pores with a pore size of 0.2 μm or less to a volume V0 of all pores is 0.40 or more when a pore distribution of the positive electrode is measured using a mercury porosimeter.

### Advantageous Effects of Invention

According to the present disclosure, it is possible to obtain an electrochemical device having an improved low-temperature property.

While novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A cross-sectional view schematically showing an exemplary structure of an electrochemical device according to this embodiment.

FIG. 2 A partially unwound perspective view schematically showing an example of an electrode group of the electrochemical device shown in FIG. 1.

### DESCRIPTION OF EMBODIMENTS

Although an embodiment of an electrochemical device according to the present disclosure will be described below using an example, the present disclosure is not limited to the example described below. Although specific numerical values and materials may be mentioned as examples in the following description, other numerical values and other materials may be used as long as effects of the present disclosure can be obtained. The term “range of numerical value A to numerical value B” used in this specification includes the numerical value A and the numerical value B, and can be read as “range of numerical value A or more to numerical value B or less”. In the following description, when lower limits and upper limits of numerical values regarding specific physical properties, conditions, or the like are given as examples, any of the above-mentioned lower limits and any of the above-mentioned upper limits can be combined, as long as the lower limit is not greater than or equal to the upper limit. In the following description, regarding any substance Z, the expression “contains Z” may encompass “a form containing Z and another substance”, “a form substantially composed of Z”, and “a form composed of Z”.

### (Electrochemical Device)

An electrochemical device according to this embodiment may be referred to as an “electrochemical device (D)” hereinafter. The electrochemical device (D) can be used as a power storage device.

The electrochemical device (D) includes a positive electrode, a negative electrode, and a lithium ion conductive electrolyte. The positive electrode includes a positive electrode mixture layer containing a positive electrode active material. The positive electrode active material contains particles of a conductive polymer to and from which anions are reversibly dopable and de-dopable. The particles may be referred to as “particles (P) hereinafter. When a pore distribution of the positive electrode is measured using a mercury porosimeter, a ratio V1/V0 of a volume V1 of pores with a pore size of 0.2 μm or less to a volume V0 of all pores is 0.40 or more. As described in the later section “Examples”, it is possible to obtain an electrochemical device having an improved low-temperature property by setting the ratio V1/V0 to 0.40 or more.

The volume V1 is the total volume of all pores with a pore size of 0.2 μm or less. The volume V0 is the total volume of all pores.

In the electrochemical device (D), the positive electrode active material (conductive polymer) is doped with anions during charge, and anions are de-doped from the positive electrode active material during discharge. Examples of doping anions into an active material include at least a phenomenon of adsorption of anions onto the active material. Examples of doping anions into the active material may include absorption of anions by the active material, chemical interaction between the active material and anions, and the like.

When anions are adsorbed on the active material, an electric double layer is formed, and capacity is developed. The positive electrode may be a polarizable electrode. The positive electrode may be an electrode that has properties of a polarizable electrode and in which the Faraday reaction also contributes to the positive electrode capacity.

The negative electrode may be, for example, doped with cations such as lithium ions while the electrochemical device is charged, and cations such as lithium ions may be de-doped from the negative electrode while the electrochemical device is discharged. Examples of doping lithium ions into a negative electrode active material include at least a phenomenon of absorption of lithium ions in the negative electrode active material. Examples of doping lithium ions into the negative electrode active material may include adsorption of lithium ions onto the negative electrode active material, chemical interaction between the negative electrode active material and lithium ions, and the like.

As the Faraday reaction in which lithium ions are absorbed by the negative electrode active material proceeds, capacity is developed. That is, the electrochemical device (D) has intermediate performance between a lithium ion secondary battery and an electric double layer capacitor, and is similar to a lithium ion capacitor.

Usually, electrochemical devices in which conductive polymers are used as active materials are likely to have poor low-temperature properties and float properties. It is inferred that the reason why low-temperature properties and float properties of the electrochemical device deteriorate is because the electrolyte solution near the active material is easily depleted and the internal resistance of the electrode increases while the electrochemical device is charged. The conductive polymer has considerably high hydrophobicity, and thus has low affinity with the electrolyte solution, and the electrolyte solution near the active material is likely to be depleted. As the internal resistance of an electrode increases, the voltage of the electrochemical device decreases, and capacity decreases. The internal resistance is likely to significantly decrease at low temperatures.

In contrast, low-temperature properties and float properties of the electrochemical device (D) can be improved by setting the ratio V1/V0 to 0.40 or more. The reason for this is not clear at present, but it is conceivable that a high proportion of small pores makes it easier for conductive paths to connect, resulting in low electrical resistance. Thus, it is conceivable that low-temperature properties and float properties can be improved by setting the ratio V1/V0 to 0.40 or more.

The ratio V1/V0 may be 0.43 or more or 0.55 or more. The ratio V1/V0 may be 1.0 or less, 0.80 or less, or 0.68 or less. A low-temperature property of the electrochemical device (D) can be particularly improved by setting the ratio V1/V0 to 0.43 or more.

The conductive polymer may include a polymer of an aniline-based compound (anilines), or may be a polymer of an aniline-based compound. A polymer of an aniline-based compound is preferable because anion doping and de-doping readily proceed. However, the conductive polymer may include a conductive polymer other than the polymers of aniline-based compounds, or may be a conductive polymer other than the polymers of aniline-based compounds.

Examples of the aniline-based compounds include aniline (C₆H₅—NH₂) and derivatives of aniline. That is, it is possible to use, as an aniline-based compound, at least one compound selected from the group consisting of aniline and aniline derivatives. Examples of the aniline derivatives include aniline to which a functional group (an alkyl group, a halogen group, or the like) is added. The functional group may be at least one selected from the group consisting of an alkyl group and a halogen group. Examples of the polymer of aniline-based compounds include polyaniline and polyaniline derivatives. Examples of the polyaniline derivatives include derivatives in which an alkyl group such as a methyl group is added to a part of the benzene ring of an aniline unit, and derivatives in which a halogen group is added to apart of the benzene ring of an aniline unit. A polymer of an aniline-based compound may be referred to as a “polyaniline-based polymer” hereinafter.

Polyaniline is a polymer of aniline. Polyaniline is a polymer having an amine structural unit of C₆H₄—NH—C₆H₄—NH— and/or an imine structural unit of C₆H₄—N═C₆H₄═N—.

The electrochemical device (D) may further include a current collector (positive electrode current collector) and a carbon layer disposed between the current collector and a positive electrode mixture layer. Specific examples of the carbon layer will be described later. If particles (P) having a small average particle size are used to set the ratio V1/V0 to 0.40 or more, adhesion between the current collector and the positive electrode mixture layer is likely to decrease. If adhesion therebetween decreases, it may become difficult to produce the electrochemical device, or properties thereof may deteriorate. By arranging the carbon layer between the current collector and the positive electrode mixture layer, it is possible to increase the adhesion between the current collector and the positive electrode mixture layer, and to reduce electrical resistance therebetween. When the average particle size of particles (P) is 5 μm or less, it is particularly preferable to arrange the carbon layer between the current collector and the positive electrode mixture layer.

The carbon layer may contain carboxymethyl cellulose ammonium (may be referred to as “CMC-NH4” hereinafter). As will be described later, in particular, adhesion between the current collector and the positive electrode mixture can be improved using CMC-NH4.

The maximum peak is preferably present in a region where the pore size is 0.2 μm or less in the log differential pore volume distribution of the positive electrode. With this configuration, it is possible to obtain an electrochemical device having an improved low-temperature property. Note that the log differential pore volume distribution is a graph in which the pore size (μm) is shown on the horizontal axis and the log differential pore volume (mL/g) is shown on the vertical axis.

The average particle size of particles (P) may be 1 μm or more or 3 μm or more, and 7 μm or less or 6 μm or less. The average particle size of particles (P) may be in a range of 3 μm to 6 μm. The ratio V1/V0 can be easily set to 0.40 or more by setting the average particle size to 7 μm or less (e.g., 6 μm or less). Also, adhesion between the current collector and the positive electrode mixture layer can be improved by setting the average particle diameter to 3 μm or more. Particles (P) having a predetermined average particle size may be produced using a known method, or commercially available particles having a predetermined average particle size may be used.

The average particle size of the particles (P) is the median diameter (D50) at which the cumulative volume is 50% in a volume-based particle size distribution. The median diameter can be determined using a laser diffraction/scattering particle size distribution analyzer.

The negative electrode may contain a negative electrode active material that reversibly absorbs and releases lithium ions. Examples of the negative electrode will be described later.

Although examples of the structure and constituent elements of the electrochemical device (D) will be described below, the structure and constituent elements of the electrochemical device (D) are not limited to the following examples. The electrochemical device (D) may include the positive electrode, the negative electrode, an electrolyte, a separator, and an exterior body.

The electrochemical device (D) may include an electrode group constituted by a positive electrode, a negative electrode, and a separator disposed between the positive electrode and the negative electrode. The electrode group may be a rolled-up type electrode group or a stacked-type electrode group. The rolled-up type electrode group is formed by rolling up the positive electrode, the negative electrode, and the separator with the separator interposed between the positive electrode and the negative electrode. The stacked type electrode group is formed by stacking the positive electrode, the negative electrode, and the separator on each other with the separator interposed between the positive electrode and the negative electrode.

### (Positive Electrode)

The positive electrode includes a positive electrode mixture layer. The positive electrode may include a positive electrode current collector and a positive electrode mixture layer. The positive electrode may further include other layers such as a carbon layer.

### (Positive Electrode Current Collector)

The positive electrode current collector may be a metal material sheet. Examples of the metal material sheet include a metal foil, a metal porous body, and an etched metal. Examples of the metal material include aluminum, aluminum alloys, nickel, and titanium. The thickness of the positive electrode current collector may be in a range of 10 μm to 100 μm.

### (Carbon Layer)

The carbon layer contains a conductive carbon material. Examples of the conductive carbon material include graphite, hard carbon, soft carbon, and carbon black. Carbon black is preferable because it is possible to forma thin carbon layer with high conductivity. The thickness of the carbon layer may be in a range of 1 μm to 20 μm.

### (Positive Electrode Mixture Layer)

The positive electrode mixture layer contains, as a positive electrode active material, particles (P) of a conductive polymer to and from which anions are reversibly dopable and de-dopable. The conductive polymer is preferably a π-conjugated polymer. As described above, a preferable example of a conductive polymer is a polymer of an aniline-based compound.

It is possible to use, as examples of π-conjugated conductive polymers other than polymers of aniline-based compounds, polypyrrole compounds, polythiophene compounds, polyfuran compounds, polythiophene vinylene compounds, and polypyridine compounds. These “compounds” include polyaniline, polypyrrole, polythiophene, polyfuran, polythiophene vinylene, and polypyridine, and derivatives thereof. Derivatives refer to polymers respectively having polyaniline, polypyrrole, polythiophene, polyfuran, polythiophene vinylene, and polypyridine as basic structures. Examples of the derivatives include derivatives in which an alkyl group such as a methyl group is added to a part of the aromatic ring of each unit, and derivatives in which a halogen group or the like is added to apart of the aromatic ring of each unit. Examples of polythiophene derivatives include poly(3,4-ethylenedioxythiophene) (PEDOT).

The positive electrode active material need only contain at least one of the above conductive polymers, and preferably contains a polyaniline-based polymer (polyanilines). The content rate of the polyaniline-based polymer in the conductive polymer contained in the positive electrode active material is preferably 50% by mass or more. The content rate may be 80% by mass or more or 90% by mass or more. The content rate is 100% by mass or less, or may be 100% by mass. All of the conductive polymers contained in the positive electrode active material may be polyaniline-based polymers.

The weight average molecular weight of a conductive polymer (e.g., polyaniline-based polymer) is not particularly limited, and may be in a range of 1000 to 100000.

The conductive polymer may contain a dopant. High conductivity is achieved by doping a π-electron conjugated polymer with a dopant Examples of the anion (dopant) that can be doped in or de-doped from a conductive polymer include a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂⁻). These anions may be used alone or in combination.

PF₆⁻ is preferably used as anion because PF₆⁻ can be readily doped in and de-doped from the conductive polymer reversibly. 90 mol % or more of all anions contained in an electrolyte may be PF₆⁻. N(FSO₂)₂⁻ is preferable as an imide ion.

The anion (dopant) may be a polymer ion. Examples of the polymer ion include anions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, polyacrylic acid, and the like. These may be homopolymers or copolymers of two or more types of monomers. These may be used alone or in combination.

Commercially available particles (P) of conductive polymer may be used. Alternatively, a conductive polymer may be synthesized through electrolytic polymerization or chemical polymerization in a reaction solution containing a raw material monomer for the conductive polymer. For example, the conductive polymer can be chemically polymerized by adding an oxidizing agent to the reaction solution containing the raw material monomer. The raw material monomer for the conductive polymer may be selected depending on the conductive polymer to be synthesized. Examples of the monomer include aniline, pyrrole, thiophene, furan, thiophene vinylene, and pyridine, and derivatives thereof. The raw material monomer may also include an oligomer.

Electrolytic polymerization or chemical polymerization may be performed using a reaction solution containing a dopant. This makes it possible to increase the amount of anions doped into the conductive polymer while the electrochemical device is being charged. However, a dopant (e.g., sulfate ion) used when performing electrolytic polymerization or chemical polymerization does not need to be the same as the dopant constituting the electrochemical device (D). For example, after electrolytic polymerization is performed using a reaction solution containing sulfate ions and raw material monomers, sulfate ions may be de-doped. This makes it possible to increase the amount of anions doped into the conductive polymer while the electrochemical device is being charged.

The positive electrode mixture layer (or an electrolyte solution) may contain sulfate ions (SO₄²⁻) in an amount of 1000 ppm or less. In such a case, deterioration of float properties can be suppressed by adding a nonionic surfactant to an electrolyte solution.

The positive electrode mixture layer may contain an additive. Examples of the additive include a binding agent, a conductive material, and a thickener. Examples of the conductive material include particulate carbon materials such as carbon black, and fibrous carbon materials such as carbon fibers, carbon nanotubes, and carbon nanofibers. Examples of the carbon black include acetylene black, Ketjenblack, and furnace black. In particular, acetylene black and Ketjenblack are preferable. Acetylene black is more preferable because it contains few impurities.

Examples of the binding agent include polycarboxylic acids, carboxymethyl cellulose, derivatives of carboxymethyl cellulose, fluororesins, and rubber materials. Examples of derivatives of carboxymethyl cellulose include sodium carboxymethyl cellulose and carboxymethyl cellulose ammonium. Examples of polycarboxylic acids include acrylic resins such as polyacrylic acid, polymethacrylic acid, and acrylic acid-methacrylic acid copolymers, and alginic acid Examples of fluororesins include polyvinylidene fluoride, polytetrafluoroethylene, and tetrafluoroethylene-hexafluoropropylene copolymers. Examples of the rubber material include styrene-butadiene rubber (SBR). These binding agents may be used alone or in combination.

The content rate of the conductive polymer in the positive electrode mixture layer may be in a range of 60% by mass to 90% by mass. The content rate of the conductive material in the positive electrode mixture layer may be in a range of 1% by mass to 30% by mass. The content rate of the binding agent in the positive electrode mixture layer may be in a range of 1% by mass to 10% by mass.

(Negative Electrode) The negative electrode includes a negative electrode mixture layer. The negative electrode may include a negative electrode current collector and a negative electrode mixture layer disposed on the negative electrode current collector.

### (Negative Electrode Current Collector)

A metal material sheet is used for the negative electrode current collector. Examples of the metal material sheet include a metal foil, a metal porous body, and an etched metal. Examples of the metal material include copper, copper alloys, nickel, and stainless steel. The thickness of the negative electrode current collector may be in a range of 10 μm to 100 μm.

### (Negative Electrode Mixture Layer)

The negative electrode mixture layer contains a negative electrode active material, and may further contain other additives (a binding agent, a conductive material, a thickener, and the like). The conductive material and the binding agent mentioned as examples in the description of the positive electrode mixture layer may be used for a conductive material and a binding agent.

Examples of the negative electrode active material include materials that electrochemically absorb and release lithium ions. Examples of such materials include carbonaceous materials, metal compounds, alloys, and ceramic materials. In particular, carbonaceous materials are preferable because they can lower the potential at the negative electrode. Graphite, hard carbon, and soft carbon are preferable as carbonaceous materials, and in particular, hard carbon is preferable. Hard carbon has a d-value of 0.38 nm or more for (002) plane obtained from an X-ray diffraction pattern. Hard carbon is preferable because it has a lower resistance and a higher capacity than graphite.

There is no limitation on the method for forming the negative electrode mixture layer, and the negative electrode mixture layer may be formed using a known method. For example, the negative electrode mixture layer may be formed using the following method. First, a negative electrode mixture paste is prepared by mixing constituent components of the negative electrode mixture layer and a dispersion medium. Then, a coating film is formed by applying the negative electrode mixture paste to the negative electrode current collector. The negative electrode mixture layer can be formed by drying the coating film. The coating film may be rolled as needed. There is no particular limitation on the dispersion medium, and water or a nonaqueous solvent may be used, or a mixture thereof may be used. There is no particular limitation on the thickness of the negative electrode mixture layer, and the thickness of the negative electrode mixture layer may be in a range of 10 μm to 300 μm.

The negative electrode mixture layer is preferably doped with lithium ions in advance (pre-doped). This reduces the potential at the negative electrode, increasing the difference (i.e., voltage) between the potential at the positive electrode and the potential at the negative electrode, thus improving the energy density of the electrochemical device.

The negative electrode may be pre-doped with lithium ions using the following method. First, a metallic lithium layer serving as a lithium ion supply source is formed on the surface of the negative electrode mixture layer. Then, the negative electrode having the metallic lithium layer is immersed in an electrolyte solution having lithium ion conductivity. At this time, lithium ions are eluted from the metallic lithium layer into the nonaqueous electrolyte solution, and the eluted lithium ions are absorbed by the negative electrode active material. For example, when graphite or hard carbon is used as a negative electrode active material, lithium ions are inserted between graphite layers or into pores of hard carbon. The negative electrode is pre-doped with lithium ions in this manner. The amount of lithium ions to be pre-doped therein can be controlled depending on the mass of the metallic lithium layer. The amount of lithium to be pre-doped may be in a range of 50% to 95% of the maximum amount by which the negative electrode mixture layer can absorb.

The step of pre-doping the negative electrode with lithium ions may be performed before the electrode group is assembled. Alternatively, pre-doping may be caused to proceed after the electrolyte solution and the electrode group are accommodated in the exterior body.

### (Separator)

There is no particular limitation on the separator, and a separator used in a known power storage device may be used Examples of the separator include nonwoven cloth made of cellulose fibers, nonwoven cloth made of glass fibers, and a microporous film, woven cloth, and nonwoven cloth made of polyolefin. The thickness of the separator may be in a range of 10 μm to 300 μm (e.g., in a range of 10 μm to 40 μm).

### (Electrolyte)

The electrolyte solution (electrolyte) has lithium ion conductivity. The electrolyte solution contains a nonaqueous solvent, a lithium salt, and a nonionic surfactant. The lithium salt is a salt of lithium ions and anions, and the anions derived from the lithium salt is doped into the positive electrode while the electrochemical device is being charged.

Examples of the lithium salt include lithium bis(fluorosulfonyl)imide (LiN(SO₂F)₂) (may be referred to as “LIFSI” hereinafter), LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, and LiN(CF₃SO₂)₂. These may be used alone or in combination.

The lithium salt may include at least one selected from the group consisting of LIFSI, LiPF₆, and LiBF₄. These lithium salts are preferable because they are highly stable and do not affect the nonionic surfactant. Furthermore, these lithium salts are also preferable because they have a high degree of dissociation and high ionic conductivity. In particular, LIFSI is more preferable because it has particularly high stability.

Nonaqueous solvents are not particularly limited and can be selected as appropriate according to the purpose. For example, it is possible to use, as a nonaqueous solvent, cyclic carbonates, such as ethylene carbonate (EC), propylene carbonate (PC), and butylene carbonate; chain carbonates, such as dimethyl carbonate (DMC), diethyl carbonate (DEC), and ethyl methyl carbonate (EMC); aliphatic carboxylic acid esters, such as methyl formate, methyl acetate, methyl propionate (PC), and ethyl propionate; lactones, such as γ-butyrolactone and γ-valerolactone; chain ethers, such as 1,2-dimethoxyethane (DME), 1,2-diethoxyethane (DEE), and ethoxymethoxyethane (EME); cyclic ethers, such as tetrahydrofuran and 2-methyltetrahydrofuran; and others, such as dimethyl sulfoxide, 1,3-dioxolane, formamide, acetamide, dimethylformamide, dioxolane, acetonitrile, propionitrile, nitromethane, ethyl monoglyme, trimethoxymethane, sulfolane, methylsulfolane, and 1,3-propane sulfone. These may be used alone or in combination.

The electrolyte solution may contain an additive as needed. For example, an unsaturated carbonate such as vinylene carbonate, vinyl ethylene carbonate, divinyl ethylene carbonate may be used as an additive for forming a film having high lithium ion conductivity on the surface of the negative electrode.

### (Exterior Body)

There is no particular limitation on the exterior body, and an exterior body used in a known power storage device may be used. The exterior body may be constituted by a metal case, a gasket, a sealing body, and the like.

### (Method for Producing Positive Electrode)

An example of a method for producing a positive electrode will be described below. The production method may be referred to as a “production method (M)” hereinafter. According to the production method (M), it is possible to produce the positive electrode of the electrochemical device (D). However, the positive electrode of the electrochemical device (D) may be produced using a method other than the production method (M). The matters described regarding the positive electrode of the electrochemical device (D) are applicable to the production method (M), and therefore their redundant description will be omitted. Also, the matters described regarding the production method (M) may be applied to the positive electrode of the electrochemical device (D).

The production method (M) includes a step (i) and a step (ii). The step (i) is a step of preparing a positive electrode mixture paste by mixing constituent components of the positive electrode mixture layer and a dispersion medium. The constituent components of the positive electrode mixture layer include particles (P) of a conductive polymer to and from which anions are reversibly dopable and de-dopable. The constituent components of the positive electrode mixture layer include other additives (a binding agent, a conductive material, a thickener, and the like) as needed. It is possible to use, as a dispersion medium, water, an organic solvent (e.g., N-methyl-2-pyrrolidone (NMP)), or a mixture thereof.

Particles (P) having the above-described average particle size can be used as the particles (P). The average particle size (P) of the particles (P) in the positive electrode mixture layer can be controlled by selecting the average particle size of particles (P) used in the step (i). Also, the content rate of each component in the positive electrode mixture layer can be controlled by changing the proportion of the component in the positive electrode mixture paste. Therefore, the proportion of each component in the positive electrode mixture layer is selected according to the content rate of the component in the positive electrode mixture layer to be formed.

The step (ii) is a step of forming a positive electrode mixture layer on a positive electrode current collector using the positive electrode mixture paste. There is no limitation on the method for forming the positive electrode mixture layer, and a known method may be used. In one example, first, a coating film is formed by applying the positive electrode mixture paste to the positive electrode current collector. Then, the positive electrode mixture layer can be formed by drying the coating film. There is no limitation on the method for applying the paste, and a known application method may be used. There is no particular limitation on the drying process, and it is sufficient that the drying conditions are selected according to the dispersion medium. For example, drying may be performed by heating the coating film at 90° C. for 5 minutes. Also, drying may be performed under reduced pressure.

The step (ii) may include a step of pressing the coating film after drying is performed. The pressure of a press may be in a range of 200 kgf/cm² to 600 kgf/cm² (in a range of 19.6 MPa to 58.8 MPa).

In the production method (M), the positive electrode mixture layer is formed such that the ratio V1/V0 has the above value (0.40 or more). The value of the ratio V1/V0 can be increased by pressing the coating film, which will be the positive electrode mixture layer. The pressure of the press may be selected according to a desired value of the ratio V1/V0. Also, the value of the ratio V1/V0 can be increased using particles (P) with a small average particle size. The average particle size of the particles (P) used in the production method (M) may be in the above-described range.

A conductive layer such as a carbon layer may be formed on the positive electrode current collector. In such a case, the positive electrode mixture layer is formed on the positive electrode current collector via the conductive layer. The carbon layer may be formed using the following method First, a carbon paste is prepared by mixing particles of a conductive carbon material and a dispersion medium. An additive (a thickener or the like) may be added to the carbon paste. Carboxymethyl cellulose ammonium (CMC-NH4) is preferable as a thickener. Water or liquid containing water can be used as the dispersion medium.

Then, the carbon layer can be formed by applying the carbon paste onto the positive electrode current collector to form a coating film, and then drying the coating film. There is no limitation on the method for applying the paste, and a known application method may be used. It is preferable to perform drying at a temperature of 130° C. or higher (e.g., in a range of 130° C. to 170° C.). By performing drying (heat treatment) at this temperature, it is possible to extract ammonia from at least a part of CMC-NH4, thereby converting CMC-NH4 into carboxymethyl cellulose (may be referred to as “CMC” hereinafter).

CMC has a lower solubility in water than CMC-NH4. Thus, the adhesion between the carbon layer and the positive electrode current collector can be increased by converting CMC-NH4 into CMC in the drying process. Furthermore, even when the water-based positive electrode mixture paste is applied when forming the positive electrode mixture layer on the carbon layer, the carbon layer is unlikely to be dissolved in water, and thus the adhesion between the carbon layer and the positive electrode mixture layer can also be increased.

On the other hand, addition of CMC to the carbon paste containing water as a dispersion medium is problematic in that the solubility of CMC in water is low. Sodium carboxymethyl cellulose (may be referred to as “CMC-Na” hereinafter) has higher solubility in water than CMC. However, unlike CMC-NH4, basically, CMC-Na is not converted into CMC through heating during drying. Thus, from the viewpoint of increasing the adhesion between the carbon layer and the positive electrode current collector, CMC-NH4 is preferably used rather than CMC-Na.

It is possible to produce the electrochemical device (D) using the positive electrode produced as described above and other constituent elements. For example, first, the electrode group is formed using the positive electrode, the negative electrode, and the separator. Then, the electrode group and the electrolyte (electrolyte solution) are enclosed in the exterior body. The electrochemical device (D) can be produced in this manner.

Hereinafter, an example of the electrochemical device (D) will be specifically described with reference to the drawings. The above-described constituent elements can be applied to constituent elements of an exemplary electrochemical device (D) described below. Also, in the example described below, constituent elements that are not essential to the electrochemical device (D) may be omitted.

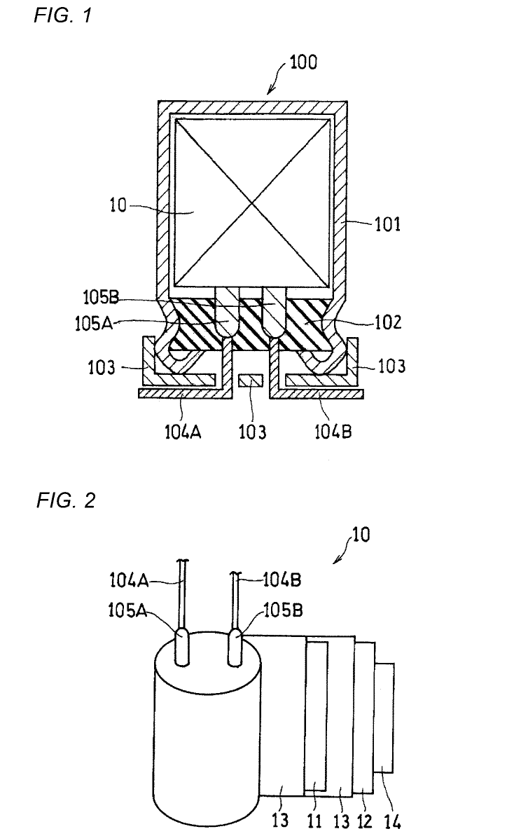

FIG. 1 is a schematic diagram showing a cross section of an electrochemical device 100 according to this embodiment. FIG. 2 is a partially unwound schematic view of an electrode group 10 included in the electrochemical device 100.

As shown in FIG. 1, the electrochemical device 100 includes the electrode group 10, a container 101, a sealing body 102, a seat plate 103, lead wires 104A and 104B, and lead tabs 105A and 105B. The container 101 accommodates the electrode group 10. The sealing body 102 closes an opening of the container 101. The seat plate 103 covers the sealing body 102. The lead tabs 105A and 105B respectively connect the lead wires 104A and 104B to electrodes of the electrode group 10. The vicinity of an open end of the container 101 is drawn inward. The open end is curled to be crimped to the sealing body 102.

The electrode group 10 includes a positive electrode 11, a negative electrode 12, and a separator 13 arranged therebetween. The positive electrode 11 and the negative electrode 12 constitute a wound body obtained by winding together the electrodes 11 and 12, and the separator 13 arranged between the electrodes 11 and 12. The outermost periphery of the wound body is fixed by a winding end tape 14. Note that FIG. 2 shows the wound body in a state in which a portion of the wound body is unwound before the outermost periphery of the wound body is fixed.

### EXAMPLES

Hereinafter, the electrochemical device according to the present disclosure will be further specifically described using examples. In the examples, a plurality of electrochemical devices (device A1 to A7, C1, and C2) were produced and evaluated.

### (Device A1)

The device A1 was produced using the following method.

### (1) Production of Positive Electrode

First, a carbon paste was prepared by mixing carbon black, carboxymethyl cellulose ammonium (CMC-NH4), and water at a mass ratio of carbon black:CMC-NH4:water=6:3:90. Then, a coating film was formed by applying the carbon paste to both surfaces of an aluminum foil (thickness: 30 μm). Thereafter, a carbon layer was formed by heating the coating film at 170° C. for 2 hours. A positive electrode core member constituted by the positive electrode current collector and the carbon layer was obtained in this manner.

A positive electrode mixture paste was prepared by mixing a conductive polymer (positive electrode active material), a dispersion of carbon black (conductive material), a dispersion of styrene-butadiene rubber (binding agent), and a solution of carboxymethyl cellulose (thickener). The mixing ratio of the conductive polymer, carbon black, styrene-butadiene rubber (SBR), and carboxymethyl cellulose (CMC) in the positive electrode mixture paste was set to the conductive polymer:carbon black:SBR:CMC=75:15:7:3 (mass ratio).

Polianiline particles with an average particle size (D50) of 3 μm were used as the conductive polymer particles (particles (P)). The dispersion of carbon black was composed of carbon black and water, and had a mass ratio of carbon black:water=20:80. Acetylene black was used as carbon black. The dispersion of SBR was composed of SBR and water, and had a mass ratio of SBR:water=40:60. The CMC solution was composed of CMC and water, and had a mass ratio of CMC:water=3:97.

Then, a coating film was formed by applying the positive electrode mixture paste to both surfaces of the positive electrode core member. Thereafter, the coating film was heated at a temperature of approximately 60° C. to 90° C. After heating was performed, the coating film was pressed using a roll press and further dried in vacuum at 110° C. for 12 hours. Pressing was performed at a pressure of 500 kgf/cm² (49 MPa). The positive electrode mixture layer (thickness: 30 μm) was formed on both surfaces of the core member in this manner. The positive electrode, in which the positive electrode mixture layer was formed on the positive electrode current collector with the carbon layer interposed therebetween, was obtained in this manner.

### (2) Production of Negative Electrode

A negative electrode mixture paste was prepared by kneading water and a powder mixture obtained by mixing 97 parts by mass of hard carbon, 1 part by mass of carboxy cellulose, and 2 parts by mass of styrene-butadiene rubber. The powder mixture and water were mixed at a mass ratio of powder mixture:water=40:60.

Then, a coating film was formed by applying the negative electrode mixture paste to both surfaces of the negative electrode current collector. A copper foil with a thickness of 20 μm was used as a negative electrode current collector. Then, the negative electrode mixture layer was formed by drying the coating film. A band-shaped negative electrode having the negative electrode mixture layer (Thickness: 35 μm) on both surfaces was obtained in this manner. Thereafter, a metallic lithium layer was formed on the negative electrode mixture layer. The amount of the metallic lithium layer was set to an amount calculated such that the negative electrode potential in the electrolyte solution after the completion of pre-doping was 0.2V or less relative to metallic lithium.

### (3) Production of Electrode Group

Lead tabs are respectively connected to the positive electrode and the negative electrode. Then, an electrode group (wound body) was produced by winding the positive electrode, the negative electrode, and the separator together. The separator is arranged between the positive electrode and the negative electrode. Nonwoven cloth (with a thickness of 35 μm) made of cellulose fibers was used as the separator.

### (4) Preparation of Electrolyte Solution (Electrolyte)

A mixture was obtained by mixing propylene carbonate and dimethyl carbonate at a volume ratio of 1:1 in a dry argon atmosphere. A solvent was prepared by adding vinylene carbonate to the mixture in an amount of 0.2% by mass. LiPF₆ was dissolved as a lithium salt in the obtained solvent. An electrolyte solution having hexafluorophosphate ions (PF₆⁻) as anions was prepared in this manner. The concentration of LiPF₆ in the electrolyte solution was 1.5 mol/L.

### (5) Production of Electrochemical Device

An electrochemical device was assembled by placing the electrode group and the electrolyte solution in a container having an opening and a bottom. Then, aging was performed at 25° C. for 24 hours while a charge voltage of 3.8 V was being applied between a terminal of the positive electrode and a terminal of the negative electrode. This aging allowed pre-doping of lithium ions into the negative electrode to proceed. The device A1 was produced in this manner.

### (Evaluation of Properties)

Properties of the device A1 were evaluated using the following method.

### (1) Measurement of Pore Distribution

A pore distribution for the positive electrode formed to produce the device A1 was measured using the following procedure. First, the device A1 was discharged until its voltage reached the lower limit of its rated voltage. At this time, the dopant is de-doped from the conductive polymer. Then, the device A1 was disassembled, and the positive electrode was removed and cleaned using a solvent having a low boiling point, such as dimethyl carbonate (DMC), and then dried. Then, a portion (with a width of approximately 1.25 and a length of approximately 2.5 cm) was cut out from the positive electrode to obtain a sample. Approximately 0.6 g of the sample was introduced into a large piece cell with a volume of 5 cc (stem volume was 0.4 cc).

Then, the pore distribution (pore volume distribution) of the sample in the cell was measured using a mercury porosimeter. Auto Pore IV manufactured by Shimadzu Corporation was used for measurement. Measurement was performed under the condition where the initial pressure was 4 kPa. As described above, the pore distribution of the sample, in which the positive electrode mixture layer was formed on both surfaces of the positive electrode core member, was measured. In this case, it is conceivable that effects of the positive electrode core member on the results of measuring the pore distribution were negligible.

The volume V1, the volume V2, and the ratio V1/V0 were determined based on the measurement results. The volume V2 is the volume of pores with a pore size of larger than 0.2 μm. The volume V0 is equal to the sum of the volume V1 and the volume V2. Furthermore, using the measurement results, it was checked whether or not the maximum peak was present in a region where the pore size was 0.2 μm or less in the log differential pore volume distribution.

### (2) Initial Internal Resistance (DCR)

The device A1 was charged at 3.6 V and discharged to 2.5 V in an environment at −30° C., and then the initial internal resistance R1 at −30° C. was determined using a voltage drop amount and a discharge current when the device A1 was discharged for a predetermined period of time.

### (3) DCR Maintenance Rate

The device A1 was charged at a voltage of 3.6 V in an environment at 25° C. Then, the device A1 was charged to 3.6 V in an environment at 60° C. and left in the environment for 1000 hours. Then, the device A1 was placed in an environment at −30° C., and the voltage drop amount and the discharge current were measured when the device A1 was discharged for a predetermined period of time. Thereafter, an internal resistance R2 at −30° C. after the high-temperature storage test was determined using the voltage drop amount and the discharge current. The DCR maintenance rate was determined using the following method, the initial internal resistance R1 and the internal resistance R2. The closer the DCR maintenance rate is to 100, the smaller a change in internal resistance is and the better the float properties are.

DCR maintenance rate (%)=100×R2/R1

### (4) Initial Capacity

The device A1 was charged at a voltage of 3.6 V and discharged until the voltage of the device A1 reached 2.5 V in an environment at −30° C. In the process, the initial capacity at a low temperature was determined by dividing the amount of discharge charge that flowed while the voltage of the device A1 decreased from 3.3 V to 3.0 V by a voltage change ΔV (=0.3 V).

### (Devices A2 to A7, C1, and C2)

Devices A2 to A7, C1, and C2 were produced using a method similar to the method for producing the device A1, except that the conditions under which the positive electrode was produced were changed. Specifically, the positive electrodes were produced by varying the value of the ratio V1/V0, whether or not the carbon layer was formed, and whether or not the coating film, which was to be a positive electrode mixture layer, was pressed, as shown in Table 1. The ratio V1/V0 was changed by varying the average particle size of the particles (P), and/or whether or not the coating film, which was to be a positive electrode mixture layer, was pressed. The coating film was pressed at a pressure of 500 kgf/cm² (49 MPa) in a similar manner to that for the Device A1. However, the coating films, which were to be the positive electrode mixture layers, were not pressed in the production of the positive electrodes of the devices A3 and A7.

Note that attempts were made to produce the positive electrode under conditions similar to those for the positive electrode of the device A1, except that no carbon layer was formed on the surface of the positive electrode current collector. However, in that case, the coating film made of the positive electrode mixture was separated from the positive electrode current collector, and a usable positive electrode was not obtained. On the other hand, the coating film was not separated from the positive electrode current collector in the production of the positive electrodes of the devices A1 to A7, C1, and C2.

The produced devices A2 to A7, C1 and C2 were evaluated in the same manner as for the device A1. However, DCR maintenance rates of the devices C1 and C2 were not evaluated.

Table 1 shows some of the conditions under which the devices were produced, and some of the evaluation results. Note that “Presence/Absence of peak” in Table 1 indicates whether or not the maximum peak is present in a region where the pore size is 0.2 μm or less in the graph of the log differential pore volume distribution. When the maximum peak was present in the region where the pore size was 0.2 μm or less, “Yes” was recorded, whereas when the maximum peak was not present, “No” was recorded. In Table 1, “pressing of coating film” indicates whether the coating film, which was to be the positive electrode mixture layer, was pressed.

TABLE 1

| | Results of Measurement of Pore Distribution | | | | Particles (P) | Carbon Layer | | |
|---|---|---|---|---|---|---|---|---|
| | Ratio | Volume V1 | Volume V2 | Presence/Absence | Average Particle | Presence/ | | Pressing of |
| | V1/V0 | (mL/g) | (mL/g) | of peak | Size D50 (μm) | Absence | Thickener | Coating Film |
| A1 | 0.65 | 0.201 | 0.107 | Yes | 3 | Yes | CMC-Na | Yes |
| A2 | 0.68 | 0.203 | 0.105 | Yes | 3 | Yes | CMC-NH4 | Yes |
| A3 | 0.43 | 0.142 | 0.188 | Yes | 3 | Yes | CMC-NH4 | No |
| A4 | 0.54 | 0.163 | 0.137 | Yes | 6 | No | None | Yes |
| A5 | 0.53 | 0.161 | 0.141 | Yes | 6 | Yes | CMC-Na | Yes |
| A6 | 0.55 | 0.164 | 0.131 | Yes | 6 | Yes | CMC-NH4 | Yes |
| A7 | 0.40 | 0.146 | 0.222 | Yes | 6 | Yes | CMC-NH4 | No |
| C1 | 0.38 | 0.129 | 0.212 | No | 9 | Yes | CMC-NH4 | Yes |
| C2 | 0.35 | 0.121 | 0.229 | No | 15 | Yes | CMC-NH4 | Yes |

Table 2 shows the results of evaluating properties of the devices. Note that the values of the initial internal resistance R1 and the initial capacity are relative values when the values of the initial internal resistance R1 and the initial capacity of the device C1 are each set to 100.0.

TABLE 2

| | Initial Internal Resistance | Initial Capacity | DCR Maintenance |
|---|---|---|---|
| | R1 (Relative Value) | (Relative Value) | Rate (%) |
| A1 | 52.7 | 259.2 | 153.4 |
| A2 | 51.4 | 260.3 | 123.4 |
| A3 | 72.7 | 216.0 | 129.8 |
| A4 | 58.1 | 217.8 | 137.9 |
| A5 | 57.9 | 218.6 | 128.2 |
| A6 | 57.6 | 219.3 | 123.4 |
| A7 | 80.1 | 180.9 | 130.7 |
| C1 | 100.0 | 100.0 | Not Evaluated |
| C2 | 119.7 | 55.0 | Not Evaluated |

As shown in Table 2, the devices A1 to A7, in which the ratio V1/V0 was 0.40 or more, had significantly better properties than the devices C1 and C2 of comparative examples, in which the ratio V1/V0 was less than 0.40. Specifically, the devices A1 to A7 had low initial internal resistance at low temperatures and high initial capacity at low temperatures.

When the ratio V1/V0 was in a range of 0.53 to 0.68, the initial internal resistance R1 was particularly low. When the ratio V1/V0 was 0.65 or more, the initial capacity was particularly high.

Regarding the device A4 in which no carbon layer was formed, the DCR maintenance rate was significantly higher than 100, and the properties significantly deteriorated. On the other hand, regarding the devices A1 to A3, in which the carbon layer was formed, an increase in the DCR maintenance rate was small. In the device, in which CMC-NH4 was used as the thickener for the carbon layer, an increase in the DCR maintenance rate was suppressed, compared to the device in which CMC-Na was used as the thickener for the carbon layer.

As is clear from a comparison between the case where the coating film was pressed and the case where the coating film was not pressed, the ratio V1/V0 was increased by pressing the coating film. Also, the ratio V1/V0 was increased using particles (P) with a small average particle size.

### INDUSTRIAL APPLICABILITY

The present disclosure can be used in electrochemical devices.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10: electrode group, 11: positive electrode, 12: negative electrode, 13: separator, 22: negative electrode, 100: electrochemical device

1. An electrochemical device comprising:
a positive electrode;
a negative electrode; and
a lithium ion conductive electrolyte,
wherein the positive electrode includes a positive electrode mixture layer containing a positive electrode active material,
the positive electrode active material contains particles of a conductive polymer to and from which anions are reversibly dopable and de-dopable, and
a ratio V1/V0 of a volume V1 of pores with a pore size of 0.2 μm or less to a volume V0 of all pores is 0.40 or more when a pore distribution of the positive electrode is measured using a mercury porosimeter.

2. The electrochemical device according to claim 1,
wherein the conductive polymer includes a polymer of an aniline-based compound.

3. The electrochemical device according to claim 1, further comprising:
a current collector; and
a carbon layer disposed between the current collector and the positive electrode mixture layer.

4. The electrochemical device according to claim 3,
wherein the carbon layer contains carboxymethyl cellulose ammonium.

5. The electrochemical device according to claim 1,
wherein a maximum peak is present in a region where the pore size is 0.2 μm or less in a log differential pore volume distribution of the positive electrode.

6. The electrochemical device according to claim 1,
wherein the particles have an average particle size of 7 μm or less.

7. The electrochemical device according to claim 1,
wherein the negative electrode contains a negative electrode active material that reversibly absorbs and releases lithium ions.
